(19) United States
(12) Patent Application Publication
(10) Pub. No.: US 2023/0408733 A1
(43) Pub. Date: Dec. 21, 2023

(54) OPTICAL BODY, MANUFACTURING METHOD OF OPTICAL BODY, LAMINATE, AND IMAGE SENSOR

(71) Applicant: Dexerials Corporation, Shimotsuke-shi, Tochigi (JP)

(72) Inventor: Shunichi KAJIYA, Shimotsuke-shi, Tochigi (JP)

(73) Assignee: Dexerials Corporation, Shimotsuke-shi, Tochigi (JP)

(21) Appl. No.: 18/255,454

(22) PCT Filed: Dec. 10, 2021
(86) PCT No.: PCT/JP2021/045716

§ 371 Date: Jun. 1, 2023

(30) Foreign Application Priority Data
Dec. 11, 2020 (JP) 2020-206295

(51) Int. Cl. G02B 1/118; G02B 5/20; G02B 1/111; G02B 1/12

(52) U.S. Cl. CPC G02B 1/118; G02B 5/208; G02B 1/111; G02B 1/12

(57) ABSTRACT

An optical body that has excellent anti-reflection performance and transmittance for light having wavelengths in the visible light band and good absorption performance for light having wavelengths in the near-infrared band is provided. To solve the above problem, the present disclosure provides an optical body 100 including a base material 20, a dye-containing resin layer 30 formed on the base material 20, and an anti-reflection layer 40 formed on the resin layer 30 and having a micro uneven structure in at least one surface. The average spectral transmittance of the optical body 100 for light in a wavelength range of 420 to 680 nm is 60% or greater, and the minimum spectral transmittance of the optical body 100 for light in a wavelength range of 750 to 1400 nm is less than 60%.

### TECHNICAL FIELD

The present disclosure relates to an optical body and a manufacturing method thereof, a laminate, and an image sensor that have excellent anti-reflection performance and transmittance for light having wavelengths in the visible light band and good absorption performance for light having wavelengths in the near-infrared band.

### BACKGROUND

Optical members installed in smartphones, tablet PCs, cameras, and the like are generally treated with anti-reflection treatment, such as forming an anti-reflection layer on a light incident surface of a base material e.g., a display panel or lens, in order to avoid deterioration of visibility and image quality (occurrence of color unevenness, ghost, or the like) caused by reflection of external light.

Here, as one of conventional anti-reflection treatments, technology in which an anti-reflection layer with a micro uneven structure (moth-eye structure) is formed on a light incident surface to reduce reflectance is known. As technology for forming a thin film with a micro uneven structure,

for example, Patent Literature (PTL) 1 discloses technology related to a transfer material, in which a carrier (10) with a nanostructured uneven structure (11) and a functional layer (12) provided on the uneven structure (11) are formed by transfer, and the average pitch of the formed uneven structure and the conditions of the functional layer are optimized for the purpose of imparting functions on a processed object with high precision.

However, the transfer material disclosed in PTL 1 can exhibit high anti-reflection performance for light with wavelengths in the visible light band, but also transmits light with longer wavelengths, such as in the near-infrared band.

When the optical members described above are used in optical devices such as CMOS image sensors, the optical members have photosensitivity over a wide wavelength band. Therefore, in consideration of application to optical devices such as image sensors, it has been desired to develop optical members that can not only suppress the reflection of light having wavelengths in the visible light band and improve transmittance, but also suppress the incidence of light having wavelengths in the near-infrared band.

### CITATION LIST

### Patent Literature

PTL 1: WO 2013/187349

### SUMMARY

### Technical Problem

In view of these circumstances, an object of the present disclosure is to provide an optical body that has excellent anti-reflection performance and transmittance for light having wavelengths in the visible light band and good absorption performance for light having wavelengths in the near-infrared band, and a manufacturing method thereof. Another object of the present disclosure is to provide a laminate and an image sensor that have excellent anti-reflection performance and transmittance for light having wavelengths in the visible light band and good absorption performance for light having wavelengths in the near-infrared band.

### Solution to Problem

As a result of conducting a series of studies in order to solve the above problem, the inventors have found out that, in an optical body including a base material, a dye-containing resin layer formed on the base material, and an anti-reflection layer formed on the resin layer and having a micro uneven structure in at least one surface, optimizing the average spectral transmittance of the optical body for light in the visible light range and the minimum spectral transmittance of the optical body for light in the near-infrared range makes it possible to improve the anti-reflection performance and transmittance for light having wavelengths in the visible light band, and to improve the absorption performance for light having wavelengths in the near-infrared band, and have completed the present disclosure.

The present disclosure is made based on the above findings, the gist of which is as follows.

(1) An optical body including:
a base material;
a dye-containing resin layer formed on the base material; and
an anti-reflection layer formed on the resin layer, the anti-reflection layer having a micro uneven structure in at least one surface,
wherein the average spectral transmittance of the optical body for light in a wavelength range of 420 to 680 nm is 60% or greater, and the minimum spectral transmittance of the optical body for light in a wavelength range of 750 to 1400 nm is less than 60%.
   (2) The optical body according to (1), wherein the anti-reflection layer has the micro uneven structure in both surfaces.
   (3) The optical body according to (1) or (2), wherein the storage elastic modulus of the resin layer is less than the storage elastic modulus of the anti-reflection layer.
   (4) The optical body according to any one of (1) to (3), wherein the thickness of the resin layer is greater than or equal to 1 μm.
   (5) The optical body according to any one of (1) to (4), wherein the thickness of the anti-reflection layer is 0.2 to 1.0 μm.
   (6) The optical body according to any one of (1) to (5), wherein a retention film is further formed on the anti-reflection layer.
   (7) A manufacturing method of an optical body, including the steps of:
making an anti-reflection layer having a micro uneven structure in a surface by curing a retention film while the retention film is pressed against a curable resin, the retention film having a micro uneven structure with an unevenness period less than or equal to a wavelength of the visible light; and
making an optical body with the retention film by, after a dye-containing curable resin is applied to a base material, curing the obtained anti-reflection layer while the anti-reflection layer is pressed against the dye-containing curable resin.

According to the above configuration, it is possible to reliably and efficiently obtain an optical body with excellent anti-reflection performance and transmittance for light with wavelengths in the visible light band and good absorption performance for light with wavelengths in the near-infrared band.

(8) A laminate including:
a retention film having a micro uneven structure with an unevenness period less than or equal to a wavelength of the visible light;
an anti-reflection layer having a micro uneven structure in at least one surface, the micro uneven structure being formed after the shape of the micro uneven structure of the retention film; and
a dye-containing resin layer formed on the anti-reflection layer.

The above configuration improves the anti-reflection performance and transmittance for light having wavelengths in the visible light band, and the absorption performance for light having wavelengths in the near-infrared band. (9) An image sensor including the optical body according to any one of (1) to (6) provided in an external light incident section.

The above configuration improves the anti-reflection performance and transmittance for light having wavelengths in the visible light band, and the absorption performance for light having wavelengths in the near-infrared band.

### Advantageous Effect

According to the present disclosure, it is possible to provide an optical body that has excellent anti-reflection performance and transmittance for light having wavelengths in the visible light band and good absorption performance for light having wavelengths in the near-infrared band, and a manufacturing method thereof. It is also possible to provide a laminate and an image sensor that have excellent anti-reflection performance and transmittance for light having wavelengths in the visible light band and good absorption performance for light having wavelengths in the near-infrared band.

### BRIEF DESCRIPTION OF THE DRAWINGS

In the accompanying drawings:

FIG. 1A is a cross-sectional view schematically illustrating an embodiment of an optical body according to the present disclosure, and FIG. 1B is a cross-sectional view schematically illustrating another embodiment of the optical body according to the present disclosure;

FIG. 2 is a cross-sectional view schematically illustrating another embodiment of the optical body according to the present disclosure;

FIGS. 3A and 3B are cross-sectional views schematically illustrating embodiments of a conventional optical body;

FIG. 4A is a cross-sectional view schematically illustrating an embodiment of a laminate according to the present disclosure, and FIG. 4B is a cross-sectional view schematically illustrating another embodiment of the laminate according to the present disclosure;

FIGS. 5A to 5H are flow diagrams illustrating an example of a method for manufacturing an optical body according to the present disclosure, and FIGS. 5A to 5H illustrate respective steps; and

FIG. 6 is a graph illustrating spectral transmission spectra versus wavelength for optical bodies of respective samples in Examples and Comparative Examples.

### DETAILED DESCRIPTION

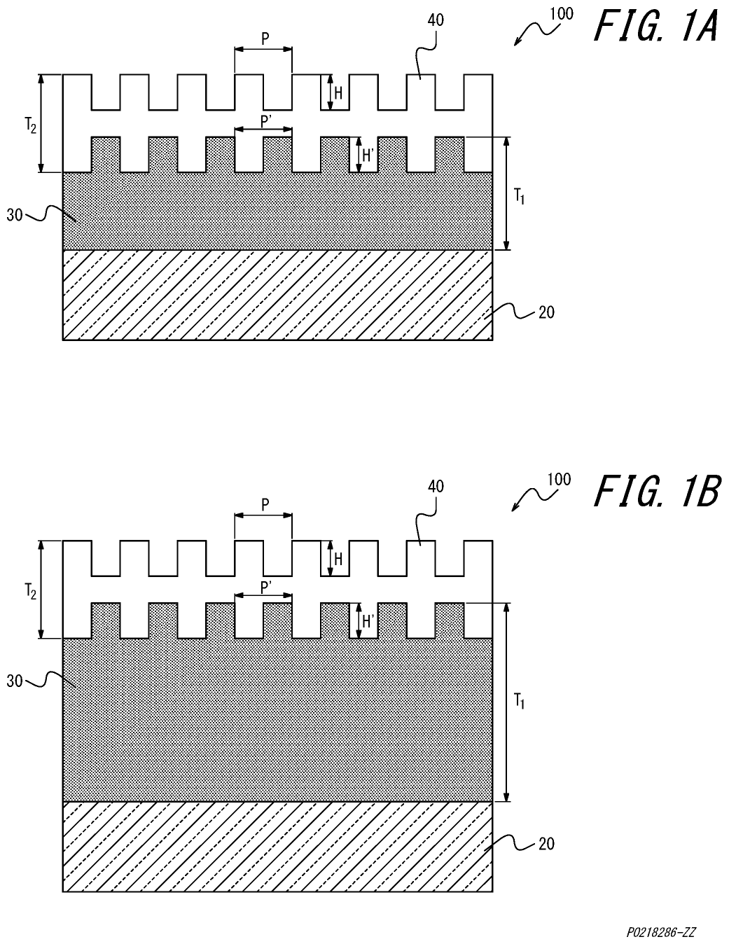

An example of an embodiment of the present disclosure will be described below in the concrete, using drawings as necessary. For convenience of explanation, each component disclosed in FIGS. 1A to 5H is represented schematically in a different scale and shape from the actual one.

### <Optical Body>

First, one embodiment of an optical body according to the present disclosure will be described.

As illustrated in FIGS. 1A and 1B, the optical body according to the present disclosure is an optical body 100 including at least the following: a base material 20, a dye-containing resin layer 30 formed on the base material and an anti-reflection layer 40 formed on the resin layer 30 and having a micro uneven structure in at least one surface (both surfaces in FIGS. 1A and 1B).

The optical body 100 according to the present disclosure is characterized in that average spectral transmittance for light in a wavelength range of 420 to 680 nm is 60% or greater, and minimum spectral transmittance for light in a wavelength range of 750 to 1400 nm is less than 60%.

By optimizing the resin layer 30 and anti-reflection layer 40 and increasing the spectral transmittance of the optical body 100 for light having wavelengths in the visible light band while reducing the spectral transmittance of the optical body 100 for light having wavelengths in the near-infrared band, it is possible to improve anti-reflection performance and transmittance for visible light and absorption performance for near-infrared light.

In addition, since the dye for absorbing light is contained in the resin layer 30, the thickness of which can be varied as desired and which has elasticity, the optical body 100 has increased absorption performance for near-infrared light while preventing cracks or other damage to the optical body.

From the viewpoint of enhancing the anti-reflection performance and transmittance for visible light, the average spectral transmittance of the optical body 100 for light in the wavelength range of 420 to 680 nm is preferably 65% or greater, and more preferably 70% or greater.

Here, the average spectral transmittance for light in the wavelength range of 420 to 680 nm is an average value of spectral transmittance for light in the wavelength range of 420 to 680 nm, and it is acceptable to have less than 60% at some wavelengths when the average value is 60% or greater. However, from the viewpoint of improving the anti-reflection performance and transmittance for visible light at a more stable and greater level, it is preferable that the transmittance be 60% or greater in any wavelength range from 20 to 680 nm.

The spectral transmittance for light incident on the optical body 100 can be measured using a commercially available spectrophotometer (e.g., V-770 or V-570 manufactured by Japan Spectroscopy, USPM-CS01 manufactured by Olympus, or the like). As a measurement method using the Olympus USPM-CS01 spectrophotometer mentioned above, measurement is performed in a wavelength band of 380 nm to 1050 nm using a transmission unit and light intensity can be set to 180 (arbitrary value).

Furthermore, from the viewpoint of further increasing the absorption performance for near-infrared light, the minimum spectral transmittance of the optical body 100 for light in the wavelength region of 750 to 1400 nm is preferably 50% or less, and more preferably 40% or less.

Here, the minimum spectral transmittance for light in the wavelength region of 750 to 1400 nm is a minimum value of spectral transmittance for light in the wavelength region of 750 to 1400 nm. It is acceptable to have a spectral transmittance of 60% or more for some wavelengths when the minimum value is less than 60%. However, from the viewpoint of improving the absorption performance for near-infrared light at a greater level, it is preferable that the spectral transmittance is preferably less than 60% at least in a wavelength region of 720 to 1000 nm.

The spectral transmittance for light incident on the optical body 100 can be measured using a commercially available spectrophotometer (e.g., V-770 or V-570 made by Japan Spectroscopy, or the like).

The components of the embodiment of the optical body 100 according to the present disclosure will be described below.

### (Base Material)

The optical body 100 according to the present disclosure includes the base material 20, as illustrated in FIGS. 1A and 1B.

Here, the base material 20 is basically a transparent substrate. By using the transparent substrate, there is no adverse effect on light transmission and the like.

In this specification, “transparent” means that the transmittance of light at wavelengths belonging to a use band (visible light and near-infrared light bands) is high, for example, the transmittance of the light is 70% or more.

The material of the base material 20 is not limited. For example, there are various types of glass, chemically strengthened glass, quartz, crystal, sapphire, polymethyl methacrylate (PMMA), cyclo-olefin polymers, cyclo-olefin copolymers, and the like, and an appropriate one can be selected according to performance required of the optical body 100. In examples of the present disclosure, white plate glass is used as the base material 20 for verification.

The shape of the base material 20 has a flat surface as illustrated in FIGS. 1A and 1B, and its size and shape are not particularly limited, and can be selected according to performance required of the optical body 1. For example, it can be a flat plate as illustrated in FIGS. 1A and 1B, or a lens-like curved surface shape.

Furthermore, the thickness of the base material 20 is not limited, and can be in a range of 0.1 to 2.0 mm, for example.

### (Resin Layer)

The optical body 100 according to the present disclosure has the resin layer 30 formed on the base material 20, as illustrated in FIGS. 1A and 1B.

In the optical body 100 according to the present disclosure, the resin layer 30 contains a dye.

Since the resin layer 30 contains the dye, absorption performance for light having specific wavelengths can be enhanced, thereby reducing spectral transmittance for near-infrared light.

In addition, the resin layer 30 can serve as an adhesive layer formed between the base material 20 and the anti-reflection layer 40 described below, and because the resin layer 30 is a flexible layer, cracks and other damage can be prevented even when the layer contains the dye. In addition, the resin layer can control the light absorption performance to a desired range by varying its thickness T₁ as appropriate.

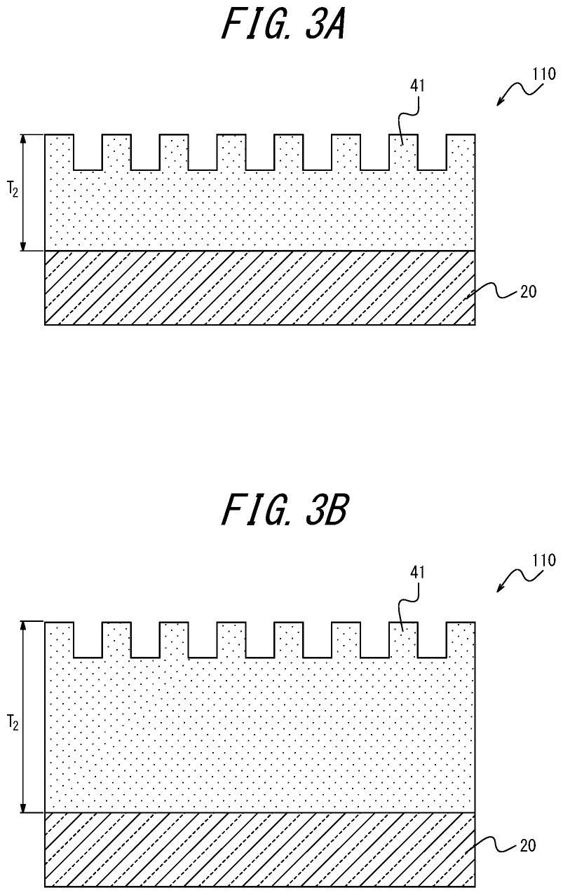

On the other hand, as illustrated in FIGS. 3A and 3B, conventional optical bodies 110 generally contain dyes in anti-reflection layers 41.

In such a case, when the anti-reflection layer 41 is designed to be as thin as a few micrometers (FIG. 3A), it is not possible to contain enough dye to achieve desired light absorption performance.

In addition, the anti-reflection layer 41 is less flexible (greater modulus of elasticity) than the resin layer 30, so when the anti-reflection layer 41 is made thicker, cracks may occur and sufficient durability cannot be ensured.

The resin layer 30 is not particularly limited, except containing the dye, and can be adjusted as appropriate according to required performance.

For example, the type and content of the dye contained in the resin layer 30, the type of resin constituting the resin layer 30, the type of monomer and oligomer, the type and content of polymerization initiators and additives, a UV irradiation time when a UV-curable resin is used as a material, or the like can be adjusted.

The content of the dye in the resin layer is not limited, but 30 mass % or less is preferable. When the content exceeds 30 mass %, there is a risk of incomplete curing due to insufficient dispersion, or bleed-out after reliability tests.

The dye is contained in the resin layer 30 to absorb light. The type of the dye is not limited and can be selected as appropriate according to the type of light to be absorbed.

For example, from the viewpoint of efficient absorption of near-infrared light, the dye preferably includes cyanine dyes with extended polymethine skeleton, phthalocyanine compounds with aluminum or zinc at the center, various naphthalocyanine compounds, nickel dithiolene complexes with planar tetracoordination structure, squalium dyes, quinone compounds, diimmonium compounds, azo compounds, and the like. Among these, the dye preferably contains at least a phthalocyanine compound. One of these compounds can be used alone, or a mixture of several compounds can be used.

As the phthalocyanine compound, there are copper-based phthalocyanine compounds (phthalocyanine blue), highly chlorinated copper-based phthalocyanine compounds (phthalocyanine green), and brominated chlorinated copper-based phthalocyanine compounds. One of these phthalocyanine compounds can be used alone or mixed with several others.

The dye can be obtained by preparing each of the dyes described above, or a commercially available dye can be purchased.

The content of the dye is not limited and can be adjusted as appropriate according to required performance (elastic modulus, manufacturability, and the like).

Materials constituting the resin layer 30, other than the dye, are not limited and can be selected as appropriate according to the required performance (elastic modulus, manufacturability, and the like).

For example, a resin composition that cures by a curing reaction can be used as resin for the resin layer 30. Among the resin composition, the resin layer 30 is preferably formed of a UV-curable adhesive. This is because high bonding properties can be achieved and good flexibility can be obtained. Examples of the UV-curable resin include UV-curable acrylate-based resins and UV-curable epoxy-based resins.

The method of forming the resin layer 30 is not limited. For example, when the resin layer 30 is a layer made of a UV-curable adhesive, the resin layer 30 can be formed by irradiating UV light while the UV-curable adhesive is crimped with the anti-reflection layer 40 described below.

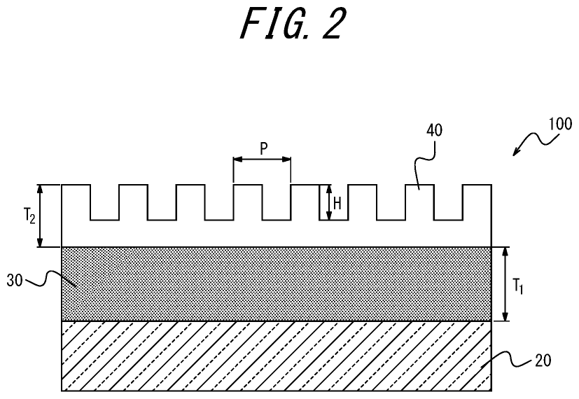

As to the shape of the resin layer 30, as illustrated in FIGS. 1A and 1B, at least a surface in contact with the anti-reflection layer 40 has a micro uneven structure. The micro uneven structure of the resin layer 30 is formed according to a micro uneven structure of the anti-reflection layer 40 described later, so conditions such as formation pitches and height of concavities and convexities are the same as those described later in a description of the anti-reflection layer Furthermore, the surface shape of the resin layer 30 can be flat on the surface in contact with the anti-reflection layer 40, as illustrated in FIG. 2.

A surface of the resin layer 30 opposite the surface in contact with the anti-reflection layer 40 is usually flat, but can be changed according to the surface shape of the base material 40 with which the resin layer 30 contacts.

Furthermore, the thickness T₁ of the resin layer 30 should have a certain degree of thickness from the viewpoint of more reliably enhancing light absorption performance. Specifically, the thickness T₁ of the resin layer 30 is preferably 1 μm or greater, and more preferably 2 μm or greater.

The thickness T₁ of the resin layer 30 is preferably 30 μm or less from the viewpoint of thinning the optical body 100, and more preferably 10 μm or less.

The thickness T₁ of the resin layer 30 is a thickness T₁ at a point at which the thickness of the resin layer 30 is greatest in a stacking direction. In FIGS. 1A and 1B, the thickness T₁ of the resin layer 30 is a distance from an apex of a convexity to an interface with the base material 20 when the surface in contact with the anti-reflection layer 40 has the micro uneven structure.

Furthermore, from the viewpoint of preventing the occurrence of cracks and the like and increasing the durability of the optical body, the storage elastic modulus of the resin layer 30 should be less than the storage elastic modulus of the anti-reflection layer 40. More specifically, the storage elastic modulus of the resin layer 30 is preferably less than 2000 MPa, and more preferably less than 1500 MPa. On the other hand, from the viewpoint of ease of manufacturing the resin layer 30, the storage elastic modulus of the resin layer 30 is preferably 100 MPa or greater.

### (Anti-reflection Layer)

As illustrated in FIGS. 1A and 1B, the optical body 100 according to the present disclosure is further provided with the anti-reflection layer 40 formed on the resin layer 30 and having a micro uneven structure (moth-eye structure) in at least one surface.

The anti-reflection layer 40 with the micro uneven structure can suppress the generation of reflected light and enhance the anti-reflection performance and transmittance of the optical body 100.

The anti-reflection layer 40 can have the micro uneven structure in both surfaces in the stacking direction as illustrated in FIGS. 1A and 1B, or in only one surface (the side of an incident surface) as illustrated in FIG. 2.

However, from the viewpoint of achieving better anti-reflection performance and transmittance, the anti-reflection layer 40 has the micro uneven structure in both the surfaces in the stacking direction.

Conditions for convexities and concavities of the micro uneven structure of the resin layer 30 are not particularly limited. For example, as illustrated in FIGS. 1A and 1B, the convexities and concavities may be arranged periodically (e.g., in a staggered or rectangular grid manner) or randomly. Furthermore, there are no limitations on the shape of the convexities and concavities, which may be bullet-shaped, cone-shaped, columnar, needle-shaped, or the like. The shape of the concavities means a shape formed by inner walls of the concavities.

Herein, the micro uneven structure formed in the anti-reflection layer 40 preferably has unevenness periods (concave-convex pitches) P and P′ that is less than or equal to a wavelength of visible light (e.g., 830 nm or less). By making the unevenness periods P and P′ of the micro uneven structure less than or equal to the visible light wavelength, in other words, by making the micro uneven structure a so-called moth-eye structure, the generation of reflected light in the visible light range can be suppressed and excellent anti-reflection performance can be achieved.

The upper limits of the unevenness periods P and P′ are preferably 350 nm or less, and more preferably 280 nm or less, from the viewpoint of more reliably suppressing reflected light of visible light. The lower limit of the unevenness periods P and P′ are preferably 100 nm or more, and more preferably 150 nm or more, from the viewpoint of manufacturability and more reliably suppressing reflected light of visible light.

Here, the unevenness periods P and P′ of the micro uneven structure formed in the anti-reflection layer 40 are arithmetic mean values of distances between adjacent convexities and between adjacent concavities. Here, the unevenness period P of the micro uneven structure can be observed, for example, by a scanning electron microscope (SEM), a cross-sectional transmission electron microscope (cross-sectional TEM), or the like.

As a method for deriving an arithmetic mean value of distances between adjacent convexities and between adjacent concavities, for example, multiple combinations of adjacent convexities and/or adjacent concavities are picked up, distances between the convexities and between the concavities constituting each combination are measured, and the measured values are averaged.

The unevenness periods P and P′ of the micro uneven structure formed in both the surfaces of the anti-reflection layer 40 can be the same (P=P′) as illustrated in FIGS. 1A and 1B, or different. However, even when the unevenness periods P and P′ of the micro uneven structure are different in each surface, each of the unevenness periods P and P′ is preferably less than or equal to a wavelength of visible light.

Average unevenness heights (the depths of concavities) H and H′ of the micro uneven structure are preferably 190 nm or more. This is for the purpose of more reliably obtaining excellent anti-reflection performance. The average concavo-convex heights H and H′ of the micro uneven structure is preferably 320 nm or less from the viewpoint of thinning a laminate.

The unevenness heights H and H′ of the micro uneven structure are each a distance from the bottom of a concavity to the top of a convexity, as illustrated in FIGS. 1A and 1B, and the average unevenness height can be obtained by measuring unevenness heights H at several locations (e.g. five locations) and calculating the average.

The thickness (thickness from the bottom of a concavity to an interface with the base material 20) of a micro uneven structure support portion of the resin layer 30, in which no micro uneven structure is formed, is not particularly limited and can be of the order of 10 to 9000 nm.

A material for making the anti-reflection layer 40 is not particularly limited. For example, there are resin compositions that cure by a curing reaction, such as active energy ray curable resin compositions (photo-curable resin compositions, electron beam curable resin compositions) and thermosetting resin compositions, and that contain a polymerizable compound and a polymerization initiator.

As the polymerizable compound, for example, (i) esterified compounds obtained by reacting one mole of polyhydric alcohol with two or more moles of (meth)acrylic acid or derivatives thereof, (ii) esterified compounds obtained from polyhydric alcohol, polyhydric carboxylic acid or its anhydride, and (meth)acrylic acid or its derivatives, and the like can be used.

As (i) above, there are 1,4-butanediol di(meth)acrylate, 1,6-hexanediol di(meth)acrylate, 1,9-nonanediol di(meth)acrylate, trimethylolpropane tri(meth)acrylate, trimethylol ethane tri(meth)acrylate, pentaerythritol tri(meth)acrylate, pentaerythritol tetra(meth)acrylate, tetrahydrofurfuryl acrylate, glycerin tri(meth)acrylate, dipentaerythritol penta(meth)acrylate, dipentaerythritol hexa(meth)acrylate, tripentaerythritol hexa(meth)acrylate, tripentaerythritol hepta(meth)acrylate, acryloymonofolin, urethane acrylate, and the like.

As (ii) above, there are esterified compounds obtained by reacting polyhydric alcohol, such as trimethylol ethane, trimethylol propane, glycerin, or pentaerythritol, with polyhydric carboxylic acid selected from malonic acid, succinic acid, adipic acid, glutaric acid, sebacic acid, fumaric acid, itaconic acid, maleic anhydride, and the like, or its anhydride, and (meth)acrylic acid or its derivatives.

One of these polymerizable compounds may be used alone or in combination with two or more.

Furthermore, when the resin composition is light curable, photoinitiators include, for example, carbonyl compounds such as benzoin, benzoin methyl ether, benzoin ethyl ether, benzoin isopropyl ether, benzoin isobutyl ether, benzyl, benzophenone, p-methoxybenzophenone, 2,2-diethoxyacetophenone, α,α-dimethoxy-α-phenylacetophenone, methylphenylglyoxylate, ethylphenylglyoxylate, 4,4′-bis(dimethylamino)benzophenone, 1-hydroxy-cyclohexyl-phenyl-ketone, and 2-hydroxy-2-methyl-1-phenylpropan-1-one; sulfur compounds such as tetramethylthiuram monosulfide and tetramethylthiuram disulfide; 2,4,6-trimethylbenzoyl-diphenyl-phosphine oxide, benzoyl diethoxyphosphine oxide, and the like. One or more of these compounds can be used.

In the case of electron beam curable, electron beam initiators include, for example, thioxanthones such as benzophenone, 4,4-bis(diethylamino)benzophenone, 2,4,6-trimethylbenzophenone, methyl orthobenzoylbenzoate, 4-phenylbenzophenone, t-butylanthraquinone, 2-ethylanthraquinone, 2,4-diethylthioxanthone, isopropylthioxanthone, 2,4-dichlorothioxanthone; acetophenones such as diethoxyacetophenone, 2-hydroxy-2-methyl-1-phenylpropan-1-one, benzyl dimethyl ketal, 1-hydroxycyclohexyl-phenyl ketone, 2-methyl-2-morpholino(4-thiomethylphenyl)propan-1-one, 2-benzyl-2-dimethyl amino-1-(4-morpholinophenyl)-butanone; benzoin ethers such as benzoin methyl ether, benzoin ethyl ether, benzoin isopropyl ether, benzoin isobutyl ether; acylphosphine oxides such as 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)-phenylphosphine oxide; methylbenzoylformate, 1,7-bisacridinylheptane, 9-phenylacridine; and the like. One or more of these can be used.

In the case of thermosetting, thermal polymerization initiators include organic peroxides such as methyl ethyl ketone peroxide, benzoyl peroxide, dicumyl peroxide, t-butyl hydroperoxide, cumene hydroperoxide, t-butyl peroxyoctoate, t-butyl peroxybenzoate, and lauroyl peroxide; azo compounds such as azobisisobutyronitrile; redox polymerization initiators that combine the organic peroxides with amines such as N,N-dimethylaniline and N,N-dimethyl-p-toluidine; and the like.

These photoinitiators, electron beam polymerization initiators, and thermal polymerization initiators may be used alone or in combination as desired.

The amount of polymerization initiator is preferably 0.01 to 10 parts by mass for 100 parts by mass of polymerizable compound. In such a range, curing progresses sufficiently, the molecular weight of a cured material becomes appropriate and sufficient strength is obtained, and problems, such as the cured material being colored due to residues of the polymerization initiator, do not occur.

In addition, the resin composition can contain non-reactive polymers and an active energy ray sol-gel reactive component as needed, and can also contain various additives such as a thickener, leveling agent, UV absorber, light stabilizer, heat stabilizer, solvent, and inorganic filler.

The thickness T₂ of the anti-reflection layer 40 should be thin from the viewpoint of thinning the optical body 100. Specifically, the thickness T₂ is preferably 10 μm or less, more preferably 5 μm or less, and particularly preferably 1.0 μm or less.

In addition, the thickness T₂ of the anti-reflection layer 40 is preferably 0.2 μm or more, and more preferably 0.5 μm or more, from the viewpoint of more reliably obtaining anti-reflection performance.

### (Other Layers)

The optical body 100 can also include other layers in addition to the base material 20, resin layer 30, and anti-reflection layer 40 described above, if necessary.

For example, when there is a refractive index difference in material between the base material 20 and the anti-reflection layer 40, one or more refractive index adjustment layers can be laminated to suppress interfacial reflection. Materials for the refractive index adjustment layers include layers made of metal oxides and coatings containing general silane coupling material agents, UV-curable resins, thermosetting resins, solvents, or the like. Furthermore, a protective layer can also be provided on the anti-reflection layer 40.

Furthermore, although the optical body 100 according to the present disclosure has the resin layer 30 and anti-reflection layer 40 in one surface of the base material 20, a multilayer anti-reflection film (multilayer AR) or an anti-reflection layer having a micro uneven structure can be further formed on the other surface of the base material 20, according to the purpose of use. For example, since the anti-reflection layer 40 has concerns about abrasion resistance and contamination resistance, it is generally difficult to use in places where its surface is exposed and may be contaminated, and it is possible to apply a highly durable coating such as a multilayer anti-reflection film in the surface on an exposed side. In addition, when light is incident from both surfaces of the optical body 100, excellent anti-reflection performance can be achieved.

Furthermore, the optical body 100 according to the present disclosure can also have a retention film 50 formed on the anti-reflection layer 40.

Here, the retention film 50 is a film used to form the micro uneven structure of the anti-reflection layer 40. The retention film 50 is used in an integrated state with the anti-reflection layer 40 during manufacture of optical body 100, and may be a component of the optical body 100.

### <Laminate>

Next, a laminate according to the present disclosure will be described.

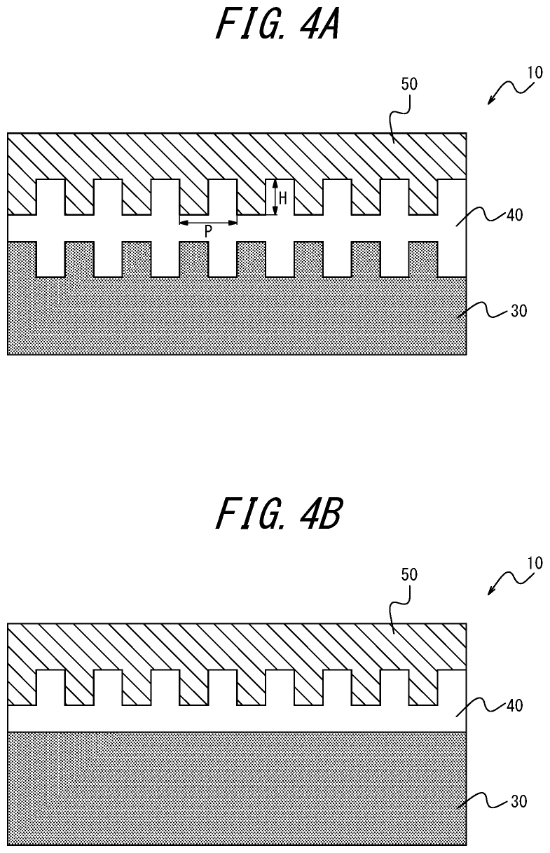

As illustrated in FIGS. 4A and 4B, a laminate 10 according to the present disclosure includes:
a retention film 50 having a micro uneven structure with an unevenness period less than or equal to a wavelength of visible light;
an anti-reflection layer 40 having, in at least one surface, a micro uneven structure formed after the shape of the micro uneven structure of the retention film 50; and
a dye-containing resin layer 30 formed on the anti-reflection layer 40 (on a surface).

When used as a material for optical bodies, the laminate 10 according to the present disclosure can improve anti-reflection performance and transmittance for light having wavelengths in the visible light band, as well as improve absorption performance for light having wavelengths in the near-infrared band.

The anti-reflection layer 40 and the resin layer 30 are the same as those described in the description of the optical body 100.

As described above, the retention film 50 is a film used to form the micro uneven structure of the anti-reflection layer 40. Since the retention film has an unevenness period of less than or equal to a wavelength of visible light, the micro uneven structure of the anti-reflection layer 40 formed by imprinting also has an unevenness period of less than or equal to the wavelength of visible light, thus providing excellent anti-reflection performance.

The material of the retention film 50 is not limited, but should be strong enough to press down a resin, such as a curable resin, that constitutes the anti-reflection layer 40 and to form the micro uneven structure, and should be a material that can transmit energy rays (heat rays, ultraviolet rays, or the like) for curing the anti-reflection layer 40.

Specifically, the retention film 50 can be made of a material such as polyethylene terephthalate (PET), polycarbonate, triacetyl cellulose, or PMMA.

A Si film or ITO (indium tin oxide) film may be formed on a surface of the retention film 50 having the micro uneven structure, for the purpose of improving adhesion with a release film containing fluorine or the like. Furthermore, a coating of release agent containing fluorine or the like may be formed between the retention film 50 and the anti-reflection layer 40.

Conditions for the unevenness period and unevenness height of the micro uneven structure of the retention film 50 are not particularly limited and are determined according to the conditions for the micro uneven structure to be formed in the anti-reflection layer 40 described above.

### <Manufacturing Method of Optical Body>

Next, a manufacturing method of an optical body according to the present disclosure will be described.

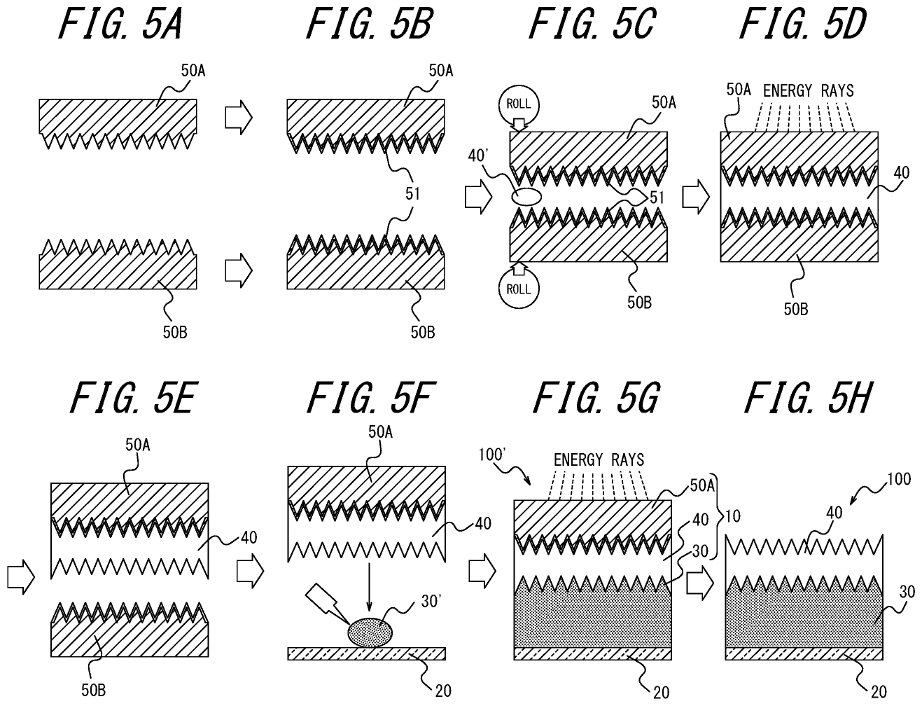

As illustrated in FIGS. 5A to 5H, the manufacturing method of an optical body according to the present disclosure is characterized in including the steps of:
making an anti-reflection layer 40 with a micro uneven structure on a surface by curing retention films 50A and 50B, which have micro uneven structures with unevenness periods less than or equal to wavelengths of visible light, while the retention films 50A and 50B are pressed against a curable resin (FIGS. 5A to 5E); and
making an optical body 100′ with the retention film 50A by, after a dye-containing curable resin 30′ is applied to a base material 20, curing the obtained anti-reflection layer 40 while the anti-reflection layer 40 is pressed against the dye-containing curable resin 30′ (FIGS. 5F to 5G).

The above manufacturing steps enable to reliably and efficiently manufacture the optical body with excellent anti-reflection performance and transmittance for light having wavelengths in the visible light band and good absorption performance for light having wavelengths in the near-infrared band.

In the step of making the anti-reflection layer 40, the retention films and 50B, which have micro uneven structures with unevenness periods less than or equal to wavelengths of visible light, are films used for forming the micro uneven structure of the anti-reflection layer 40, as described above, and the conditions of the films are described in the laminate according to the present disclosure.

As illustrated in FIG. 5B, Si layers, ITO films, coatings of a mold release agent, or the like can be formed as top layers 51 of the micro uneven structures of the retention films 50A and 50B.

In the step of making the anti-reflection layer 40, conditions for pressing the retention films 50A and 50B onto the curable resin 40′ are not limited. For example, as illustrated in FIG. 5C, the retention films 50A and can be pressed from both sides by applying pressure with rolls while the curable resin 40′ is sandwiched between the retention films 50A and 50B′.

Furthermore, in the step of making the anti-reflection layer 40, conditions for curing the curable resin 40′ are not limited. The types and conditions of the curable resin 40′ and energy rays can be selected according to required performance. The type of the curable resin 40′ is the same as that described in the description of the optical body according to the present disclosure. The type of the energy rays includes, for example, ultraviolet rays, heat rays, moisture, and the like, and is determined depending on the type of the curable resin 40′. The irradiation of the energy rays is not limited to after pressing by the retention films 50A and 50B, but can also be performed at the same timing as pressing.

After the curable resin 40′ has cured, the anti-reflection layer 40 is obtained by removing the retention film 50B on one side, as illustrated in FIG. 5E. When the coatings of the release agent are applied as the top layers 51 of the retention films 50A and 50B, the operation of removing the retention film becomes easier. The other retention film 50A is not removed in this step because the retention film 50A forms the laminate 10 together with the dye-containing curable resin 30′ in the subsequent step and becomes a component of the optical body 100′.

In the step of making the optical body 100′, as illustrated in FIG. 5F, after the dye-containing curable resin 30′ is applied on the base material 20, the anti-reflection layer 40 integrated with the retention film 50A is pressed against the curable resin 30′.

Then, as illustrated in FIG. 5G, the anti-reflection layer 40 is cured while being pressed against the dye-containing curable resin 30′. Conditions for curing are not limited, and the types and conditions of the curable resin 30′ and energy rays can be selected according to required performance. The type of the curable resin 30′ is the same as that described in the description of the optical body according to the present disclosure. The type of the energy rays includes, for example, ultraviolet rays, heat rays, moisture, and the like, and is determined depending on the type of the curable resin 30′. The irradiation of the energy rays is not limited to after pressing by the anti-reflection layer 40, but can be performed at the same timing as pressing.

From the optical body 100′ obtained as described above, the retention film 50A attached to the anti-reflection layer 40 is removed as illustrated in FIG. 5H, so an optical body 100 in the form used for an image sensor or the like is obtained. The obtained optical body 100 can then be subjected to various treatments such as washing, as necessary.

### <Optical Device>

An optical device according to the present disclosure is characterized in including the above-described optical body according to the present disclosure. This enables the optical device to achieve excellent anti-reflection performance and transmittance for light having wavelengths in the visible light band while also improving absorption performance for light having wavelengths in the near-infrared band, resulting in improved optical properties over a wide range of wavelengths from the visible light band to the near-infrared band.

The optical device according to the present disclosure is not particularly limited except that the above-described optical body according to the present disclosure is provided as a component, and other components can be provided as appropriate depending on the type of device, required performance, and other factors.

The optical device is not limited. For example, there are devices such as imaging devices or imaging modules, image sensors, devices such as sensors using infrared rays or the like, as well as smart phones, personal computers, portable game machines, televisions, video cameras, and means of transportation such as automobiles and airplanes equipped with these devices. Among these, it is preferred that the optical device is an image sensor.

When the optical body according to the present disclosure is provided in the image sensor, the optical body can be provided in an external light incident section. This more reliably improves optical characteristics over a wide range of wavelengths from the visible light band to the near-infrared band.

### EXAMPLES

Next, the present disclosure will be specifically described based on examples. However, the present disclosure is not limited in any way to the following examples.

### Comparative Example 1

As illustrated in FIG. 3A, on a glass substrate (“slide glass S1127” manufactured by Matsunami Glass Ind., Ltd.) 20 with a thickness of 1.1 mm, an anti-reflection layer 40 having a storage elastic modulus of 2 GPa, a thickness T₂ of 1 μm, an unevenness period P of a micro uneven structure of a range of 150 to 230 nm, and an unevenness height of 200 nm, and containing a dye as a near-infrared light absorbing material was formed to manufacture an optical body 110, which was a sample of Comparative Example 1.

As a curable resin that makes up the anti-reflection layer 40, a curable resin composition was used in which “UVX-6366” (hard coating resin with pentaerythol tetraacrylate as a main ingredient) manufactured by Toagosei Co., Ltd., tetrahydrofurfuryl alcohol (THFA), and 1,6-hexanediol diacrylate (HDDA) were mixed in the ratio of 6:2:2, and 2 mass % of phthalocyanine dye (“FDN005” by Yamada Chemical Co., Ltd.) as a near-infrared light absorbing material, and 2 mass % of “Irgacure 184” (1-hydroxycyclohexylphenyl ketone) manufactured by BASF as a UV curing initiator were added.

The micro uneven structure of the anti-reflection layer 40 was formed by transfer molding using a retention film 50A having a micro uneven structure. The retention film 50A was made of a transparent polyester film (“Cosmo Shine A4300” manufactured by Toyobo Co., Ltd.) with a thickness of 125 μm. On a surface of the micro uneven structure of the retention film, a Si film with a thickness of 20 nm was formed by sputtering, and the Si film was coated with a fluorine mold release agent (“Novec® (Novec is a registered trademark in Japan, other countries, or both) 1720” manufactured by 3M). In the sample of Comparative Example 1, the anti-reflection layer 40 has the micro uneven structure in only one surface (light incident surface).

Furthermore, as conditions for forming the anti-reflection layer 40, the retention film 50A was pressed at 500 g/5 cm square, and after pressing, ultraviolet rays were applied by a point light source UV lamp (“LC-8” manufactured by Hamamatsu Photonics K.K.) at 1000 mJ for 360 seconds, and then the retention film 50A was removed, to form the optical body 110.

### Comparative Example 2

As illustrated in FIG. 3B, on a glass substrate (“slide glass S1127” manufactured by Matsunami Glass Ind., Ltd.) 20 with a thickness of 1.1 mm, an anti-reflection layer 40 having a storage elastic modulus of 2 GPa, a thickness T₂ of 3 μm, an unevenness period P of a micro uneven structure of 150 to 230 nm, and an unevenness height of 200 nm, and containing a dye as a near-infrared light absorbing material was formed to manufacture an optical body 110, which was a sample of Comparative Example 2.

All other conditions (composition of a curable resin, conditions of a retention film 50A, conditions for forming the anti-reflection layer 40, and the like) are the same as in Comparative Example 1.

### Example 1

As illustrated in FIG. 1A, on a glass substrate (“slide glass S1127” manufactured by Matsunami Glass Ind., Ltd.) 20 with a thickness of 1.1 mm, a resin layer 30 having a storage elastic modulus of 1 GPa and a thickness T₁ of 5 μm and containing a dye as a near-infrared light absorbing material, and an anti-reflection layer 40 having a storage elastic modulus of 2 GPa, a thickness T₂ of 1 μm, an unevenness period P of a micro uneven structure of a range of 150 to 230 nm, and an unevenness height of 200 nm were formed to manufacture an optical body 100, which was a sample of Example 1.

As a curable resin that makes up the anti-reflection layer 40, a curable resin composition was used in which “UVX-6366” (hard coating resin with pentaerythol tetraacrylate as a main ingredient) manufactured by Toagosei Co., Ltd., tetrahydrofurfuryl alcohol (THFA), and 1,6-hexanediol diacrylate (HDDA) were mixed in the ratio of 6:2:2, and 2 mass % of “Irgacure 184” (1-hydroxycyclohexylphenyl ketone) manufactured by BASF as a UV curing initiator were added.

The micro uneven structure of the anti-reflection layer 40 was formed, as illustrated in FIGS. 5A to 5C, by transfer molding using retention films 50A and 50B having micro uneven structures. Both the retention films 50A and 50B were made of transparent polyester films (“Cosmo Shine A4300” manufactured by Toyobo Co., Ltd.) with a thickness of 125 μm. On surfaces of the micro uneven structures of the retention films, a Si film with a thickness of 20 nm was formed by sputtering, and the Si film was coated with a fluorine mold release agent (“Novec® 1720” manufactured by 3M). In the sample of Example 1, the anti-reflection layer 40 has the micro uneven structure in only one surface (light incident surface).

Furthermore, as conditions for forming the anti-reflection layer 40, as illustrated in FIGS. 5C to 5D, the retention film 50A was pressed at 500 g/5 cm square, and after pressing, ultraviolet rays were applied by a point light source UV lamp (“LC-8” manufactured by Hamamatsu Photonics K.K.) at 1000 mJ for 360 seconds, and then the retention film 50B was removed, to form an optical body 110.

For the resin layer 30, a curable resin composition was used in which 2 mass % of phthalocyanine dye (“FDN005” by Yamada Chemical Co., Ltd.) as a near-infrared light absorbing material and 2 mass % of “Irgacure 184” (1-hydroxycyclohexylphenyl ketone) manufactured by BASF as a UV curing initiator were added to a UV-curable resin (“17C0-029” manufactured by Toagosei Co., Ltd.).

Furthermore, as for conditions for forming the resin layer 30, after the curable resin composition was dropped and applied on the base material 20 by a dropper as illustrated in FIG. 5F, the anti-reflection layer 40 integrated with the retention film 50A was pressed at a pressure of 500 g/5 cm square, as illustrated in FIG. 5G. After pressing, ultraviolet rays were applied by a planar excimer lamp (“EX-400” manufactured by Hamamatsu Photonics K.K.) at 1000 mJ for 360 seconds, to form an optical body 100′. Then the optical body 100 was obtained by removing the retention film 50A.

### Example 2

As illustrated in FIG. 1B, on a glass substrate (“slide glass S1127” manufactured by Matsunami Glass Ind., Ltd.) 20 with a thickness of 1.1 mm, a resin layer 30 having a storage elastic modulus of 1 GPa and a thickness T₁ of 15 μm and containing a dye as a near-infrared light absorbing material, and an anti-reflection layer 40 having a storage elastic modulus of 2 GPa, a thickness T₂ of 1 μm, an unevenness period P of a micro uneven structure of a range of 150 to 230 nm, and an unevenness height of 200 nm were formed to manufacture an optical body 100, which was a sample of Example 2.

All other conditions (composition of a curable resin, conditions of retention films 50A and 50B, conditions for forming the anti-reflection layer conditions for forming the resin layer 30, and the like) are the same as in Example 1.

### Evaluation

The following evaluations were performed on each sample of laminate obtained in each Examples and Comparative Examples. Table 1 indicates evaluation results.

### (1) Optical Characteristics

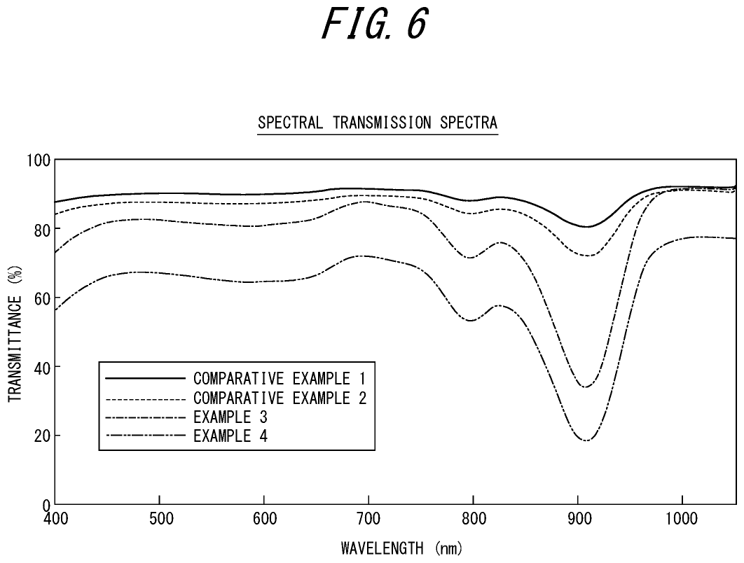

The spectral transmission spectra of the respective samples of the obtained optical bodies were measured by a spectrophotometer (V-570 manufactured by JASCO Corporation). FIG. 6 indicates obtained results.

### (2) Durability

The respective samples of the obtained optical bodies were subjected to a heat shock test in which the samples were held at −40° C. for 15 minutes, the ambient temperature was increased to 85° C. in 3 minutes, and the samples were held at 85° C. for 15 minutes, for a total of 300 cycles. After the heat shock test, the condition of each sample was observed under an optical microscope and evaluated according to the following criteria. Table 1 indicates evaluation results.
O: No cracks found.
x: Cracks were found.

TABLE 1

| | Comparative Examples | | Examples | |
|---|---|---|---|---|
| | 1 | 2 | 1 | 2 |
| Evaluation result of heat shock test | ∘ | x | ∘ | x |

The results in FIG. 6 indicate that both the optical bodies of Comparative Examples and Examples have excellent transmittance for light having wavelengths in the visible light range and excellent anti-reflection performance. On the other hand, for light having wavelengths in the near-infrared range, the optical bodies of Examples 1 and 2 both have low transmittance (excellent absorption performance), while the optical bodies of Comparative Examples 1 and 2 are not able to suppress transmittance and are not able to sufficiently absorb light with wavelengths in the near-infrared range.

It is also found from Table 1 that the optical bodies of Comparative Example 1 and Examples 1 to 2, which are within the scope of the present disclosure, have sufficient durability. On the other hand, it is found that the sample of Comparative Example 2 does not have sufficient durability due to cracks occurring in the dye-containing anti-reflection layer.

### INDUSTRIAL APPLICABILITY

According to the present disclosure, it is possible to provide an optical body that has excellent anti-reflection performance and transmittance for light having wavelengths in the visible light band and good absorption performance for light having wavelengths in the near-infrared band, and a manufacturing method thereof. According to the present disclosure, it is also possible to provide a laminate and an image sensor that have excellent anti-reflection performance and transmittance for light having wavelengths in the visible light band and good absorption performance for light having wavelengths in the near-infrared band.

### REFERENCE SIGNS LIST

10 laminate
20 base material
30 resin layer
30′ curable resin
40, 41 anti-reflection layer
40′ curable resin
50, 50A, 50B retention film
51 top layer
100, 100′ optical body
110 optical body
T₁ thickness of resin layer
T₂ thickness of anti-reflection layer
P, P′ unevenness period of micro uneven structure in anti-reflection layer
H, H′ unevenness height of micro uneven structure in anti-reflection layer

1. An optical body comprising:
a base material;
a dye-containing resin layer formed on the base material; and
an anti-reflection layer formed on the resin layer, the anti-reflection layer having a micro uneven structure in at least one surface,
wherein average spectral transmittance of the optical body for light in a wavelength range of 420 to 680 nm is 60% or greater, and minimum spectral transmittance of the optical body for light in a wavelength range of 750 to 1400 nm is less than 60%.

2. The optical body according to claim 1, wherein the anti-reflection layer has the micro uneven structure in both surfaces.

3. The polarization element according to claim 1, wherein storage elastic modulus of the resin layer is less than storage elastic modulus of the anti-reflection layer.

4. The optical body according to claim 1, wherein thickness of the resin layer is greater than or equal to 1 μm.

5. The optical body according to claim 1, wherein thickness of the anti-reflection layer is 0.2 to 1.0 μm.

6. The optical body according to claim 1, wherein a retention film is further formed on the anti-reflection layer.

7. A manufacturing method of an optical body, comprising the steps of:
making an anti-reflection layer having a micro uneven structure in a surface by curing a retention film while the retention film is pressed against a curable resin, the retention film having a micro uneven structure with an uneven period less than or equal to a wavelength of visible light; and
making an optical body with the retention film by, after a dye-containing curable resin is applied to a base material, curing the obtained anti-reflection layer while the anti-reflection layer is pressed against the dye-containing curable resin.

8. A laminate comprising:
a retention film having a micro uneven structure with an unevenness period less than or equal to a wavelength of visible light;
an anti-reflection layer having a micro uneven structure in at least one surface, the micro uneven structure being formed after shape of the micro uneven structure of the retention film; and
a dye-containing resin layer formed on the anti-reflection layer.

9. An image sensor comprising the optical body according to claim 1 provided in an external light incident section.
